(19) United States
(12) Patent Application Publication
(10) Pub. No.: US 2024/0095522 A1
(43) Pub. Date: Mar. 21, 2024

(54) NEURAL NETWORK GENERATION DEVICE, NEURAL NETWORK COMPUTING DEVICE, EDGE DEVICE, NEURAL NETWORK CONTROL METHOD, AND SOFTWARE GENERATION PROGRAM

(71) Applicant: LeapMind Inc., Tokyo (JP)

(72) Inventor: Hiroyuki TOKUNAGA, Tokyo (JP)

(21) Appl. No.: 18/263,051

(22) PCT Filed: Feb. 1, 2022
(86) PCT No.: PCT/JP2022/003745

§ 371 Date: Jul. 26, 2023

(30) Foreign Application Priority Data
Feb. 1, 2021 (JP) 2021-014621

(51) Int. Cl. G06N 3/08

(52) U.S. Cl. CPC G06N 3/08

(57) ABSTRACT

A neural network generation device that generates a neural network execution model for performing operations of a neural network wherein the neural network execution model converts input data including elements with 8 bits or more to converted values with fewer bits than the elements, based on comparisons with multiple threshold values.

### CROSS-REFERENCE TO RELATED APPLICATIONS

The present application is a U.S. national phase of International Patent Application No. PCT/JP2022/003745, filed on Feb. 1, 2022, which, in turn, is based upon and claims the right of priority to Japanese Patent Application No. 2021-014621, tiled on Feb. 1, 2021, the disclosures of both of which are hereby incorporated by reference herein in their entirety for all purposes.

### TECHNICAL FIELD

The present invention relates to a neural network generation device, a neural network computing device, an edge device, a neural network control method, and a software generation program.

### BACKGROUND ART

In recent years, convolutional neural networks (CNNs) have been used as models for image recognition and the like. Convolutional neural networks have a multilayered structure with convolution layers and pooling layers, and require many operations such as convolution operations. Various computation techniques that accelerate operations by convolutional neural networks have been proposed (Patent Document 1, etc.).

### CITATION LIST

### Patent Documents

[Patent Document 1] JP 2018-077829 A

### SUMMARY OF INVENTION

### Technical Problem

Meanwhile, image recognition or the like utilizing convolutional neural networks is also used in embedded devices such as IoT devices. The generation of circuits and models that perform operations associated with neural networks adapted to the hardware configurations of embedded devices is sought in order to efficiently operate convolutional neural networks in the embedded devices. Additionally, a control method for operating these circuits and models with high efficiency and at high speed is also sought. Additionally, a software generation program that generates software for operating these circuits and models with high efficiency and at high speed is also sought.

In consideration of the above-mentioned circumstances, an objective of the present invention is to provide a neural network generation device that is embeddable in an embedded device such as an IoT device and that generates circuits and models for performing operations associated with a neural network that can operate with high efficiency and at high speed, a neural network computing device that performs operations associated with a neural network that can operate with high efficiency and at high speed, an edge device that includes the neural network computing device, a neural network control method that operates, with high efficiency and at high speed, circuits and models for performing operations associated with a neural network, and a software generation program that generates software for operating, with high efficiency and at high speed, circuits and models for performing operations associated with a neural network.

### Solution to Problem

In order to solve the above-mentioned problems, the present invention proposes the features indicated below

A neural network generation device according to a first embodiment of the present invention is a neural network generation device that generates a neural network execution model for performing operations of a neural network, wherein the neural network execution model converts input data including elements with S bits or more to converted values with fewer bits than the elements, based on comparisons with multiple threshold values.

### Advantageous Effects of Invention

The neural network generation device, the neural network computing device, the edge device, the neural network control method, and the software program of the present invention are embeddable in an embedded device such as an IoT device, and can generate and control a neural network that can be made to operate with high performance.

### BRIEF DESCRIPTION OF DRAWINGS

FIG. 1 is a diagram illustrating a neural network generation device according to a first embodiment.

FIG. 2 is a diagram illustrating inputs to and outputs from a computation unit in the neural network generation device.

FIG. 3 is a diagram illustrating an example of a convolutional neural network.

FIG. 4 is a diagram for explaining a convolution operation performed by a convolution layer in the convolutional neural network.

FIG. 5 is a diagram illustrating an example of a neural network execution model.

FIG. 6 is a timing chart indicating an example of operations in the neural network execution model.

FIG. 7 is a control flow chart of the neural network generation device.

FIG. 8 is an internal block diagram of a convolution operation circuit that is generated.

FIG. 9 is an internal block diagram of a multiplier in the convolution operation circuit.

FIG. 10 is an internal block diagram of a multiply-add computation unit in the multiplier.

FIG. 11 is an internal block diagram of an accumulator circuit in the convolution operation circuit.

FIG. 12 is an internal block diagram of an accumulator unit in the accumulator circuit.

FIG. 13 is a state transition diagram of a control circuit in the convolution operation circuit.

FIG. 14 is a block diagram of an input conversion unit in the convolution operation circuit.

FIG. 15 is a diagram for explaining data partitioning and data expansion in the convolution operation.

FIG. 16 is a diagram for explaining an example of electronic equipment (neural network computing device) according to a second embodiment.

FIG. 17 is a timing chart indicating an example of operations in the electronic equipment.

FIG. 18 is a flow chart indicating operations performed by a program for converting input data executed by a processor in the electronic equipment.

### DESCRIPTION OF EMBODIMENTS

### First Embodiment

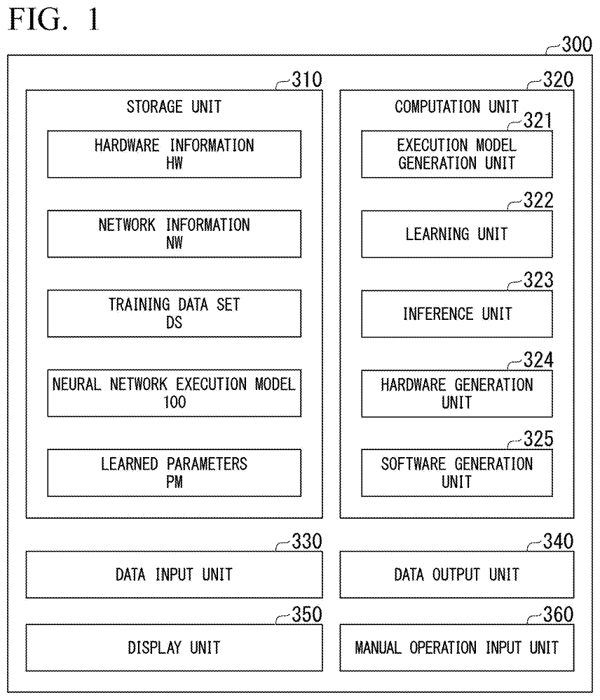

A first embodiment of the present invention Till be explained with reference to FIG. 1 to FIG. 15.

FIG. 1 is a diagram illustrating a neural network generation device 300 according to the present embodiment.

### [Neural Network Generation Device 300]

The neural network generation device 300 is a device that generates a trained neural network execution model 100 that is embeddable in an embedded device such as an IoT device. The neural nets network execution model 100 is a software or hardware model generated for performing the operations of a convolutional neural network 200 (hereinafter referred to as “CNN 200”) in an embedded device.

The neural network generation device 300 is a program-executable device (computer) provided with a processor such as a CPU (Central Processing Unit) and hardware such as a memory. The functions of the neural network generation device 300 are realized by executing a neural network generation program and a software generation program in the neural network generation device 300. The neural network generation device 300 is provided with a storage unit 310, a computation unit 320, a data input unit 330, a data output unit 340, a display unit 350, and a manual operation input unit 360.

The storage unit 310 stores hardware information HW, network information NW, a training data set DS, a neural network execution model 100 (hereinafter referred to as an “NN execution model 100”), and learned parameters PM. The hardware information HW, the training data set DS, and the network information NW are input data that are input to the neural network generation device 300. The NN execution model 100 and the learned parameters PM are output data that are output by the neural network generation device 300. The “trained NN execution model 100” includes the NN execution model 100 and the learned parameters PM.

The hardware information HW is information regarding an embedded device in which the NN execution model 100 is to be operated (hereinafter referred to as “operated hardware”). The hardware information HW is, for example, the device type of the operated hardware, a device constraint, a memory configuration, a bus configuration, an operating frequency, power consumption, a manufacturing process type, or the like. The device type is, for example, a type such as an ASIC (Application-Specific Integrated Circuit) or an FPGA (Field-Programmable Gate Array). The device constraint is the upper limit of the number of processors included in the operated device, the upper limit of the circuit size, or the like. The memory configuration is the memory type, the number of memory units, the memory capacity, or the input/output data width. The bus configuration is the bus type, the bus width, the bus communication standard, connected devices on the same bus, or the like. Additionally, in the case in which there are multiple variations of the NN execution model 100, the hardware information HW includes information regarding the variations of the NN execution model 100 to be used.

The network information NW is basic information regarding the CNN 200. The network information NW is, for example, the network configuration of the CNN 200, input data information, output data information, quantization information, or the like. The input data information is the input data type such as images or audio, the input data size, or the like.

The training data set DS includes training data D1 used for training and test data D2 used for inference tests.

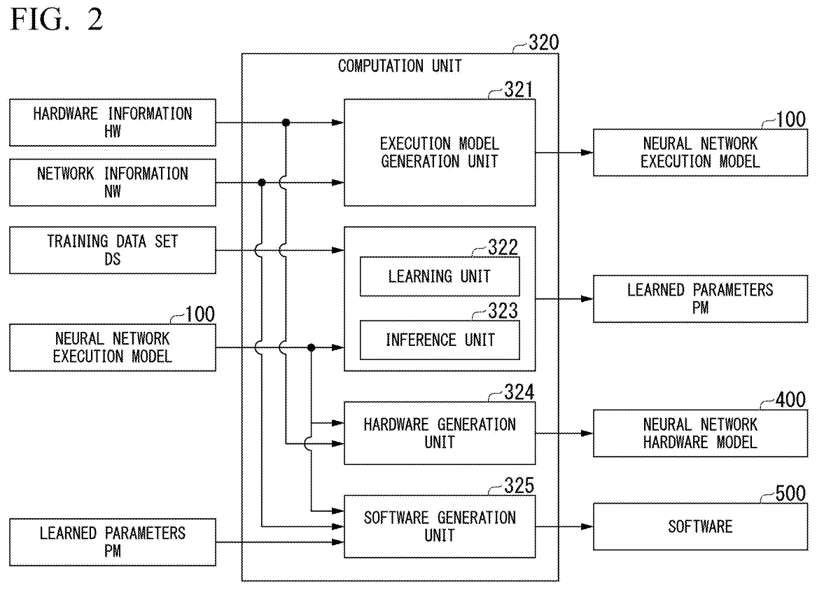

FIG. 2 is a diagram illustrating input to and output from the computation unit 320.

The computation unit 320 has an execution model generation unit 321, a learning unit 322, an inference unit 323, a hardware generation unit 324, and a software generation unit 325. The NN execution model 100 input to the computation unit 320 may be generated by a device other than the neural network generation device 300.

The execution model generation unit 321 generates an NN execution model 100 based on the hardware information HW and the network information NW. The NN execution model 100 is a software or hardware model generated for making the CNN 200 perform operations with the operated hardware. The software includes software for controlling the hardware model. The hardware model may be at the behavior level, may be at the RTL (Register Transfer Level), may be a net list representing connections between gates and circuit modules, or may be a combination thereof.

The learning unit 322 uses the NN execution model 100 and the training data D1 to generate learned parameters PM. The inference unit 323 uses the NN execution model 100 and test data D2 to implement an inference test.

The hardware generation unit 324 generates a neural network hardware model 400 based on the hardware information HW and the NN execution model 100. The neural network hardware model 400 is a hardware model that can be installed in the operated hardware. The neural network hardware model 400 is optimized for the operated hardware based on the hardware information HW. The neural network hardware model 400 may be at the RTL (Register Transfer Level), may be a net list indicating connections between gates and circuit modules, or may be a combination thereof. The neural network hardware model 400 may be a parameter list or a configuration file necessary for installing the NN execution model 100 on the hardware. The parameter list or the configuration file is used in combination with the separately generated NN execution model 100.

In the description hereinafter, the neural network hardware model 400 installed on the operated hardware will be referred to as “neural network hardware 600”.

The software generation unit 325 generates software 500 for operating the neural network hardware 600 based on the network information NW and the NN execution model 100. The software 500 includes software for transferring trained parameters PM to the neural network hardware 600 as needed.

Hardware information HW, network information NW, and the like necessary for generating the trained NN execution model 100 are input to the data input unit 330. The hardware information HW, the network information NW, and the like are input, for example, as data written in a prescribed data format. The hardware information HW, the network information NW, and the like that have been input are stored in the storage unit 310. The hardware information HW, the network information NW, and the like may be input or changed by the user from the manual operation input unit 360.

A trained NN execution model 100 that has been generated is output to the data output unit 340. For example, the generated NN execution model 100 and learned parameters PM are output to the data output unit 340.

The display unit 350 has a known type of monitor such as an LCD display. The display unit 350 can display GUI (Graphical User Interface) images generated by the computation unit 320, a console screen for receiving commands or the like, or the like. Additionally, in the case in which the computation unit 320 requires information to be input by the user, the display unit 350 can display a message prompting the user to input information from the manual operation input unit 360, or a GUI image required for inputting information.

The manual operation input unit 360 is a device for the user to input instructions to the computation unit 320 or the like. The manual operation input unit 360 is a known type of input device such as a touch panel, a keyboard, or a mouse. The inputs to the manual operation input unit 360 are transmitted to the computation unit 320.

Some or all of the functions of the computation unit 320 are realized, for example, by one or more processors like a CPU (Central Processing Unit) or a GPU (Graphics Processing Unit) executing a program stored in a program memory. However, some or all of the functions of the computation unit 320 may be realized by hardware (e.g., circuitry) such as an LSI (Large-Scale Integrated circuit), an ASIC (Application-Specific Integrated Circuit), an FPGA (Field-Programmable Gate Array), or a PLD (Programmable Logic Device). Additionally, some or all of the functions of the computation unit 320 may be realized by combining software with hardware.

Some or all of the functions of the computation unit 320 may be realized by using a CPU or a GPU provided in an external device such as a cloud server, or an external accelerator such as hardware. The computation speed of the computation unit 320 can be improved, for example, by using the computation unit 320 in conjunction with dedicated hardware or a GPU having high computational performance on a cloud server.

The storage unit 310 is realized by means of flash memory, an EEPROM (Electrically Erasable Programmable Read-Only Memory), a ROM (Read-Only Memory), a RAM (Random Access Memory), or the like. All or some of the storage unit 310 may be provided in an external device such as a cloud server, and may be connected to the computation unit 320 or the like by a communication line.

### [Convolutional Neural Network (CNN) 200]

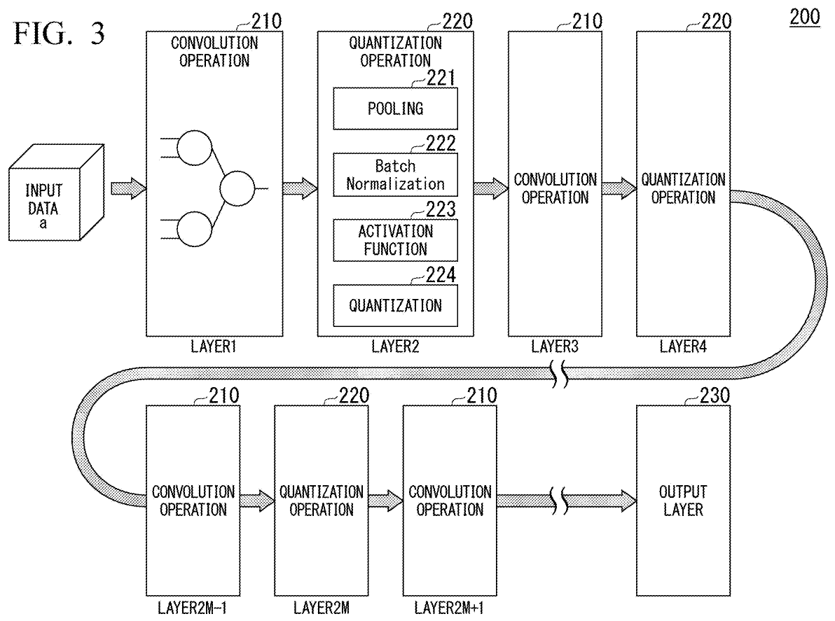

Next, the CNN 200 will be explained. FIG. 3 is a diagram illustrating an example of a CNN 200. The network information NW in the CNN 200 is information regarding the configuration of the CNN 200 explained below. The CNN 200 uses low-bit weights and quantized input data a, and can easily be embedded in an embedded device.

The CNN 200 is a network having a multilayered structure, including convolution layers 210 that perform convolution operations, quantization operation layers 220 that perform quantization operations, and an output layer 230. In at least part of the CNN 200, the convolution layers 210 and the quantization operation layers 220 are connected in an alternating manner. The CNN 200 is a model that is widely used for image recognition and video recognition. The CNN 200 may further have a layer with another function, such as a fully connected layer.

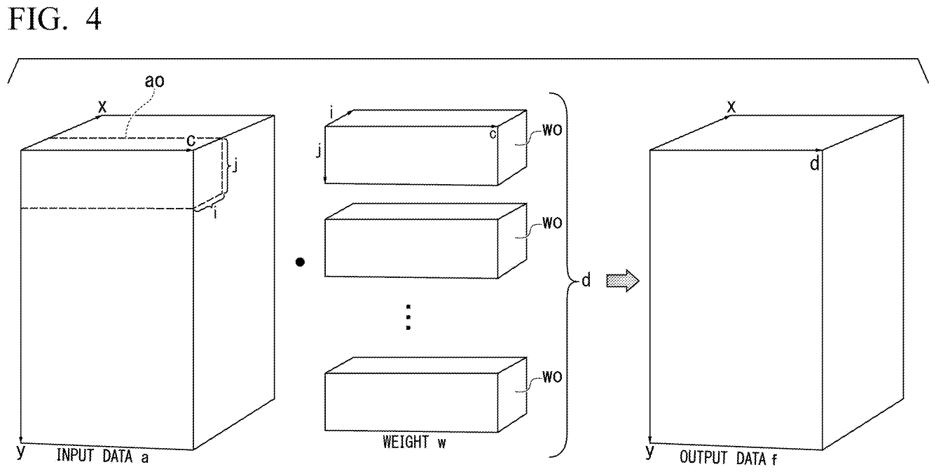

FIG. 4 is a diagram explaining the convolution operations performed by the convolution layers 210.

The convolution layers 210 perform convolution operations in which weights w are used on input data a. The convolution layers 210 perform multiply-add operations with the input data a and the weights w as inputs.

The input data a (also referred to as activation data or a feature map) that is input to the convolution layers 210 is multi-dimensional data such as image data. In the present embodiment, the input data a is a three-dimensional tensor comprising elements (x, y, c). The convolution layers 210 in the CNN 200 perform convolution operations on the low-bit input data a. In the present embodiment, the elements of the input data a are 2-bit unsigned integers (0, 1, 2, 3). The elements of the input data a may, for example, be 4-bit or 8-bit unsigned integers.

If the input data that is input to the CNN 200 is in a format, e.g., of the 32-bit floating-point type, different from the format of the input data a input to the convolution layers 210, then the CNN 200 may further have an input layer for performing type conversion or quantization in front of the convolution layers 210.

The weights w (also referred to as filters or kernels) in the convolution layers 210 are multi-dimensional data having elements that are learnable parameters. In the present embodiment, the weights w are four-dimensional tensors comprising the elements (i, j, c, d). The weights w include d three-dimensional tensors (hereinafter referred to as “weights wo”) comprising the elements (i, j, c). The weights w in the trained CNN 200 are learned data. The convolution layers 210 in the CNN 200 use low-bit weights w to perform the convolution operations. In the present embodiment, the elements of the weights w are 1-bit signed integers (0, 1), where the value “0” represents +1 and the value “1” represents −1.

The convolution layers 210 perform the convolution operation indicated in Equation 1 and output the output data f. In Equation 1, s indicates a stride. The region indicated by the dotted line in FIG. 4 represents one region ao (hereinafter referred to as “application region ao”) in which the weights wo are applied to the input data a. The elements of the application region ao can be represented by (x+i, y+j, c).

f(x, y, d)=Σᵢ^{k}Σⱼ^{k}Σ_{c}^{C}a(s·x+i, s·y+j, c)·w(i, j, c, d) [Equation 1]

The quantization operation layers 220 implement quantization or the like on the convolution operation outputs that are output by the convolution layers 210. The quantization operation layers 220 each have a pooling layer 221, a batch normalization layer 222, an activation function layer 223, and a quantization layer 224.

The pooling layer 221 performs operations such as average pooling (Equation 2) and max pooling (Equation 3) on the convolution operation output data f output by a convolution layer 210, thereby compressing the output data f from the convolution layer 210. In Equation 2 and Equation 3, u indicates an input tensor, v indicates an output tensor, and T indicates the size of a pooling region. In Equation 3, max is a function that outputs the maximum value of u fur combinations of i and j contained in T.

$$v ( x , y , c ) = \frac{1}{{T}^{2}} {\sum }_{i}^{T} {\sum }_{j}^{T} u ( T \cdot x + i , T \cdot y + j , c ) \qquad [ Equation 2 ]$$

$$v ( x , y , c ) = max ( u ( T \cdot x + i , T \cdot y + j , c ) ) , i ∈ T , j ∈ T \qquad [ Equation 3 ]$$

The batch normalization layer 222 normalizes the data distribution of the output data from a quantization operation layer 220 or a pooling layer 221 by means of an operation as indicated, for example, by Equation 4. In Equation 4, u indicates an input tensor, v indicates an output tensor, a indicates a scale, and B indicates a bias. In a trained CNN 200, a and B are learned constant vectors.

v(x, y, c)=a(c)·(u(x, y, c)−B(c)) [Equation 4]

The activation function layer 223 performs activation function operations such as ReLU (Equation 5) on the outputs from a quantization operation layer 220, a pooling layer 221, or a batch normalization layer 222. In Equation 5, u is an input tensor and v is an output tensor. In Equation 5, max is a function that outputs the argument having the highest numerical value.

v(x, y, c)=max(0, u(x, y, c) [Equation 5]

The quantization layer 224 performs quantization as indicated, for example, by Equation 6, on the outputs from a pooling layer 221 or an activation function layer 223, based on quantization parameters. The quantization indicated by Equation 6 reduces the bits in the input tensor u to 2 bits. In Equation 6, q(c) is a quantization parameter vector. In the trained CNN 200, q(c) is a learned constant vector. In Equation 6, the inequality signs “≤” may be replaced with “<”.

$$\begin{matrix}qtz ( x , y , c ) = 0 if u ( x , y , c ) ≦ q ( c ) . th 0 else \\ 1 if u ( x , y , c ) ≦ q ( c ) . th 1 else \\ 2 if u ( x , y , c ) ≦ q ( c ) . th 2 else \\ 3\end{matrix} \qquad [ Equation 6 ]$$

The output layer 230 is a layer that outputs the results from the CNN 200 by means of an identity function, a softmax function, or the like. The layer preceding the output layer 230 may be either a convolution layer 210 or a quantization operation layer 220.

In the CNN 200, quantized output data from the quantization layers 224 are input to the convolution layers 210. Thus, the load of the convolution operations in the convolution layers 210 is smaller than that in other convolutional neural networks in which quantization is not performed.

### [Neural Network Execution Model 100 (NN Execution Model) 100]

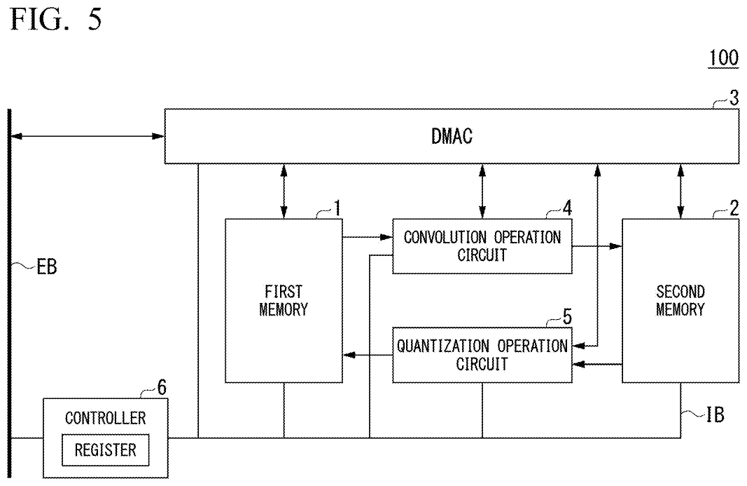

Next, the NN execution model 100 will be explained. FIG. 5 is a diagram illustrating an example of the NN execution model 100. The NN execution model 100 is a software or hardware model generated for making the CNN 200 perform operations in the operated hardware. Software includes software for controlling a hardware model. The hardware model may be at the behavior level, may be at the RTL (Register Transfer Level), may be a net list indicating connections between gates and circuit modules, or may be a combination thereof.

The NN execution model 100 is provided with a first memory 1, a second memory 2, a DMA controller 3 (hereinafter also referred to as “DMAC 3”), a convolution operation circuit 4, a quantization operation circuit 5, and a controller 6. The NN execution model 100 is characterized in that the convolution operation circuit 4 and the quantization operation circuit 5 form a loop with the first memory 1 and the second memory 2 therebetween.

The first memory 1 is a rewritable memory such as a volatile memory composed, for example, of SRAM (Static RAM) or the like. Data is written into and read from the first memory 1 via the DMAC 3 and the controller 6. The first memory 1 is connected to an input port of the convolution operation circuit 4, and the convolution operation circuit 4 can read data from the first memory 1. Additionally, the first memory 1 is connected to an output port of the quantization operation circuit 5, and the quantization operation circuit 5 can write data into the first memory 1. An external host CPU can input and output data with respect to the NN execution model 100 by writing and reading data with respect to the first memory 1.

The second memory 2 is a rewritable memory such as a volatile memory composed, for example, of SRAM (Static RAM) or the like. Data is written into and read from the second memory 2 via the DMAC 3 and the controller 6. The second memory 2 is connected to an input port of the quantization operation circuit 5, and the quantization operation circuit 5 can read data from the second memory 2. Additionally, the second memory 2 is connected to an output port of the convolution Operation circuit 4, and the convolution operation circuit 4 can write data into the second memory 2. An external host CPU can input and output data with respect to the NN execution model 100 by writing and reading data with respect to the second memory 2.

The DMAC 3 is connected to an external bus EB and transfers data between an external memory, such as a DRAM, and the first memory 1. Additionally, the DMAC 3 transfers data between an external memory, such as a DRAM, and the second memory 2. Additionally, the DMAC 3 transfers data between an external memory, such as a DRAM, and the convolution operation circuit 4. Additionally, the DMAC 3 transfers data between an external memory, such as a DRAM, and the quantization operation circuit 5.

The convolution operation circuit 4 is a circuit that performs a convolution operation in a convolution layer 210 in the trained CNN 200. The convolution operation circuit 4 reads input data a stored in the first memory 1 and implements a convolution operation on the input data a. The convolution operation circuit 4 writes output data f (hereinafter also referred to as “convolution operation output data”) from the convolution operation into the second memory 2.

The quantization operation circuit 5 is a circuit that performs at least part of a quantization operation in a quantization operation layer 220 in the trained CNN 200. The quantization operation circuit 5 reads the output data f from the convolution operation stored in the second memory 2, and performs a quantization operation (among pooling, batch normalization, an activation function, and quantization, the operation including at least quantization) on the output data f from the convolution operation. The quantization operation circuit 5 writes the output data (hereinafter also referred to as “quantization operation output data”) out from the quantization operation into the first memory 1.

The controller 6 is connected to the external bus EB and operates as a slave to an external host CPU. The controller 6 has a register 61 including a parameter register and a state register. The parameter register is a register for controlling the operation of the NN execution model 100. The state register is a register indicating the state of the NN execution model 100, including semaphores S. The external host CPU can access the register 61 via the controller 6.

The controller 6 is connected, via an internal bus IB, to the first memory 1, the second memory 2, the DMAC 3, the convolution operation circuit 4, and the quantization operation circuit 5. The external host CPU can access each block via the controller 6. For example, the external host CPU can issue commands to the DMAC 3, the convolution operation circuit 4, and the quantization operation circuit 5 via the controller 6. Additionally, the DMAC 3, the convolution operation circuit 4, and the quantization operation circuit 5 can update the state register (including the semaphores S) in the controller 6 via the internal bus IB. The state register (including the semaphores S) may be configured to be updated via dedicated lines connected to the DMAC 3, the convolution operation circuit 4, or the quantization operation circuit 5.

Since the NN execution model 100 has a first memory 1, a second memory 2, and the like, the number of data transfers of redundant data can be reduced in the data transfers by the DMAC 3 from external memory such as a DRAM. As a result thereof, the power consumption due to memory access can be largely reduced.

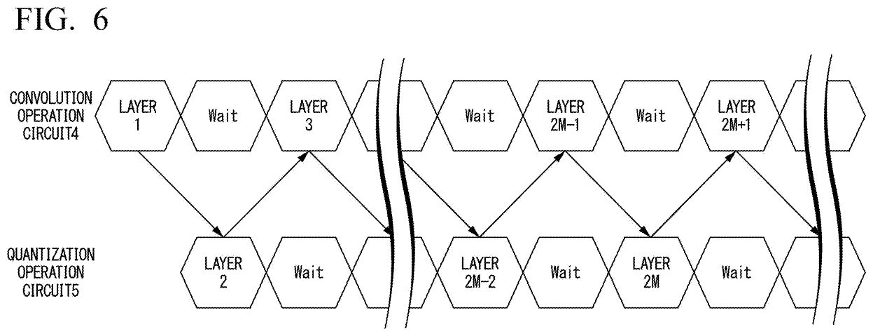

FIG. 6 is a timing chart indicating examples of operations in the NN execution model 100. The NN execution model 100 performs operations for the CNN 200, which has a multilayered structure with multiple layers, by means of circuits forming loops, The NN execution model 100 can make efficient use of hardware resources due to the looped circuit configuration. Hereinafter, examples of operations in the neural network hardware 600 indicated in FIG. 6 will be explained.

The DMAC 3 stores the input data a input to layer 1 (see FIG. 3) in the first memory 1. The DMAC 3 may transfer the input data a input to layer 1 after partitioning the data in accordance with the order of convolution operations performed by the convolution operation circuit 4.

The convolution operation circuit 4 reads out the input data a input to layer 1 (see FIG. 3) stored in the first memory 1. The convolution operation circuit 4 performs a layer-1 convolution operation on the input data a input to layer 1. The output data f from the layer-1 convolution operation is stored in the second memory 2.

The quantization operation circuit 5 reads the output data f from layer 1 stored in the second memory 2. The quantization operation circuit 5 performs a layer-2 quantization operation on the output data f from layer 1. The output data out from the laver-2 quantization operation is stored in the first memory 1.

The convolution operation circuit 4 reads the output data from the layer-2 quantization operation stored in the first memory 1. The convolution operation circuit 4 performs a layer-3 convolution operation using the output data out from the layer-2 quantization operation as the input data a. The output data f from the layer-3 convolution operation is stored in the second memory 2.

The convolution operation circuit 4 reads the output data out from a layer-(2M−2) (M being a natural number) quantization operation stored in the first memory 1. The convolution operation circuit 4 performs a layer-(2M−1) convolution operation using the output data out from the layer-(2M−2) quantization operation as the input data a. The output data f from the layer-(2M−1) convolution operation is stored in the second memory 2.

The quantization operation circuit 5 reads the output data f from layer (2M−1) stored in the second memory 2. The quantization operation circuit 5 performs a layer-2M quantization operation on the output data f from layer (2M−1). The output data out from the layer-2M quantization operation is stored in the first memory 1.

The convolution operation circuit 4 reads the output data out from the layer-2M quantization operation stored in the first memory 1. The convolution operation circuit 4 performs a layer-(2M+1) convolution operation using the output data out from the layer-2M quantization operation as the input data a. The output data f of the layer-(2M+1) convolution operation is stored in the second memory 2.

The convolution operation circuit 4 and the quantization operation circuit 5 perform operations in an alternating manner to carry out the operations of the CNN 200 indicated in FIG. 3. In the MN execution model 100, the convolution operation circuit 4 implements the layer-(2M−1) and layer-(2M+1) convolution operations in a time-divided manner. Additionally, in the NN execution model 100, the quantization operation circuit 5 implements the layer-(2M−1) and layer-2M quantization operations in a time-divided manner. For this reason, the NN execution model 100 has an extremely small circuit size in comparison with the case in which separate convolution operation circuits 4 and quantization operation circuits 5 are provided for each layer.

### [Operations of Neural Network Generation Device 300]

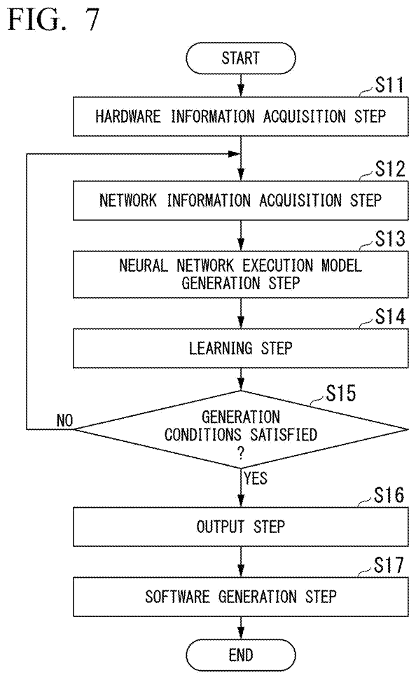

Next, the operations (neural network control method) of the neural network generation device 300 will be explained by following the control flow chart for the neural network ;veneration device 300 indicated in FIG. 7. The neural network generation device 300 implements an initialization process (step S10), then executes step S11.

### <Hardware Information Acquisition Step (S11)>

In step S11, the neural network generation device 300 acquires hardware information HW for the operated hardware (hardware information acquisition step). The neural network generation device 300, for example, acquires hardware information HW input to the data input unit 330. The neural network generation device 300 may display a GUI image necessary for inputting the hardware information HW on the display unit 350, and may acquire the hardware information HW by having a user input the hardware information HW from the manual operation input unit 360.

The hardware information HW specifically includes a memory type, a memory capacity, and an input/output data width for memory allocated to the first memory 1 and the second memory 2.

The acquired hardware information HW is stored in the storage unit 310. Next, the neural network generation device 300 executes step S12.

### <Network Information Acquisition Step (S12)>

In step S12, the neural network generation device 300 acquires network information NW for the CNN 200 (network information acquisition step), The neural network generation device 300 acquires, for example, network information NW input to the data input unit 330. The neural network generation device 300 may display a GUI image necessary for inputting the network information NW on the display unit 350, and may acquire the network information NW by having a user input the network information NW from the manual operation input unit 360.

The network information NW specifically includes the network configuration including the input layer and the output layer 230, the configuration of the convolution layers 210 including the bit widths of weights w and input data a, and the configuration of the quantization operation layers 220 including quantization information.

The acquired network information NW is stored in the storage unit 310. Next, the neural network generation device 300 executes step S13.

### <Neural Network Execution Model Generation Step (S13)>

In step S13, the execution model generation unit 321 in the neural network generation device 300 generates an NN execution model 100 based on the hardware information HW and the network information NW (neural network execution model generation step).

The neural network execution model generation step (NN execution model generation step) involves, for example, a convolution operation circuit generation step (S13-1), a quantization operation circuit generation step (S13-2), and a DMAC generation step (S13-3).

### <Convolution Operation Circuit Generation Step (S13-1)>

The execution model generation unit 321 generates the convolution operation circuit 4 of the NN execution model 100 based on the hardware information HW and the network information NW (convolution operation circuit generation step). The execution model generation unit 321 generates the hardware model of the convolution operation circuit 4 from information such as the bit widths of the weights w and the input data a that are input as network information NW. The hardware model may be at the behavior level, may be at the RTL (Register Transfer Level), may be a net list indicating connections between gates and circuit modules, or may be a combination thereof. Hereinafter, an example of a hardware model of the convolution operation circuit 4 that is generated will be explained.

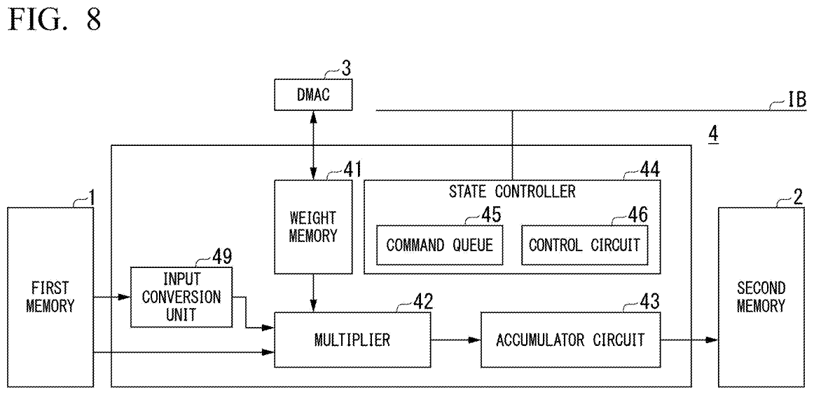

FIG. 8 is an internal block diagram of a generated convolution operation circuit 4.

The convolution operation circuit 4 has a weight memory 41, a multiplier 42, an accumulator circuit 43, a state controller 44, and an input conversion unit 49. The convolution operation circuit 4 has a state controller 44 that is dedicated to the multiplier 42 and the accumulator circuit 43 so that, when a command is input, a convolution operation can be implemented without requiring an external controller.

The weight memory 41 is a memory in which weights w used in convolution operations are stored, and may, for example, be a rewritable memory, such as a volatile memory composed of an SRAM (Static RAM) or the like. The DMAC 3 writes the weights w necessary for convolution operations into the weight memory 41 by means of DMA transfer.

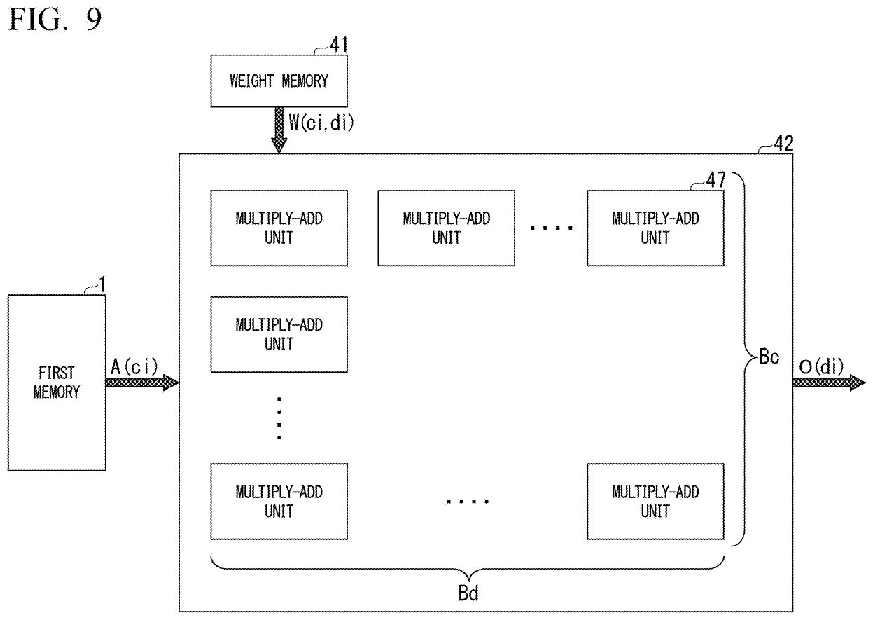

FIG. 9 is an internal block diagram of the multiplier 42.

The multiplier 42 multiplies the respective elements of the input data a with the respective elements of the weights w. The respective elements of the input data a are data obtained by partitioning the input data a, and are vector data having Bc elements (for example, the “input vector A” described below). Additionally, the respective elements of the weights w are data obtained by partitioning the weights w, and constitute the matrix data (for example, the “weight matrix W” described below) having Bc×Bd elements. The multiplier 42 has Bc×Bd multiply-add computation units 47 and can implement, in parallel, the multiplication of the input vector A with the weight matrix W.

The multiplier 42 implements the multiplication by reading out the input vector A and the weight matrix W necessary for the multiplication from the first memory 1 and the weight memory 41. The multiplier 42 outputs Bd multiply-add operation results O(di).

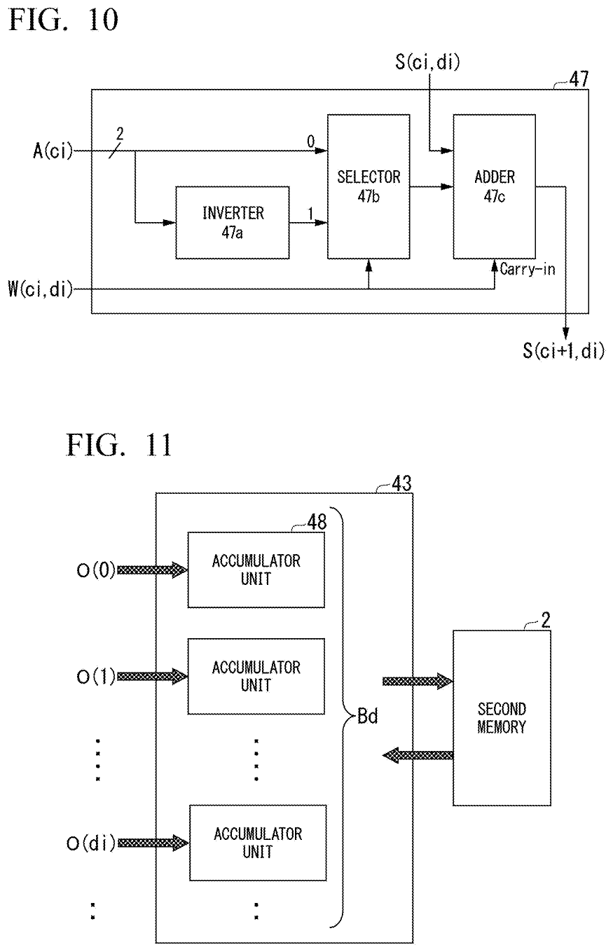

FIG. 10 is an internal block diagram of a multiply-add computation unit 47.

The multiply-add computation unit 47 implements multiplication between the elements A(ci) of the input vector A and the elements W(ci, di) of the weight matrix W. Additionally, the multiply-add computation unit 47 adds the multiplication results to the multiplication results S(ci, di) from other multiply-add computation units 47. The multiply-add computation unit 47 outputs the addition results S(ci+1, di). The ci is an index from 0 to (Bc−1). The di is an index from 0 to (Bd−1). The elements A(ci) are 2-bit unsigned integers (0, 1, 2, 3). The elements W(ci, di) are 1-bit signed integers (0, 1), where the value “0” represents +1 and the value “1” represents −1.

The multiply-add computation unit 47 has an inverter 47a, a selector 47b, and an adder 47c. The multiply-add computation unit 47 performs multiplication using only the inverter 47a and the selector 47b, without using a multiplier. When the element W(ci, di) is “0”, the selector 47b selects to input the element A(ci). When the element W(ci, di) is “1”, the selector 47b selects a complement obtained by inverting the element A(ci) by means of the inverter. The element W(ci, di) is also input to Carry-in on the adder 47c. When the element W(ci, di) is “0”, the adder 47c outputs a value obtained by adding the element A(ci) to S(ci, di). When W(ci, di) is “1”, the adder 47c outputs a value obtained by subtracting the element A(ci) from S(ci, di).

FIG. 11 is an internal block diagram of the accumulator circuit 43.

The accumulator circuit 43 accumulates, in the second memory 2, the multiply-add operation results O(di) from the multiplier 42. The accumulator circuit 43 has Bd accumulator units 48 and can accumulate lid multiply-add operation results O(di) in the second memory 2 in parallel.

FIG. 12 is an internal block diagram of the accumulator unit 48.

The accumulator unit 48 has an adder 48a and a mask unit 48b. The adder 48a adds an element O(di) of the multiply-add operation results O to a partial sum that is obtained midway through the convolution operation indicated by Equation 1 stored in the second memory 2. The addition results have 16 bits per element. The addition results are not limited to having 16 bits per element, and for example, may have 15 bits or 17 bits per element.

The adder 48a writes the addition results at the same address in the second memory 2. If an initialization signal “clear” is asserted then the mask unit 48b masks the output from the second memory 2 and sets the value to be added to the element O(di) to zero. The initialization signal “clear” is asserted when the partial sum that is obtained midway is not stored in the second memory 2.

When the convolution operation by the multiplier 42 and the accumulator circuit 43 is completed, output data f(x, y, do) having Bd elements is stored in the second memory.

The state controller 44 controls the states of the multiplier 42 and the accumulator circuit 43. Additionally, the state controller 44 is connected to the controller 6 via the internal bus IB. The state controller 44 has a command queue 45 and a control circuit 46.

The command queue 45 is a queue in which commands C4 for the convolution operation circuit 4 are stored, and is constituted, for example, by an FIFO memory. Commands C4 are written into the command queue 45 via the internal bus IB.

The control circuit 46 is a state machine that decodes the commands C4 and that controls the multiplier 42 and the accumulator circuit 43 based on the commands C4. The control circuit 46 may be implemented by a logic circuit, or may be implemented by a CPU controlled by software.

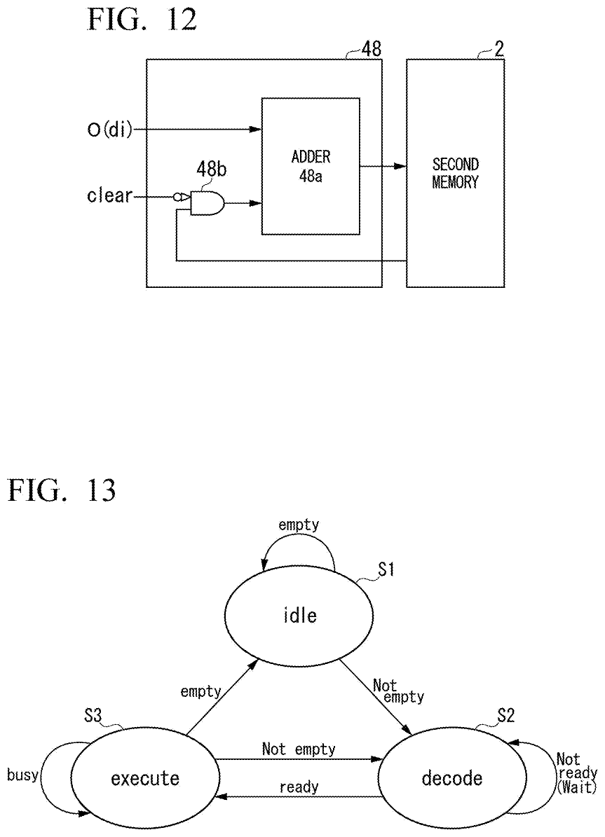

FIG. 13 is a state transition diagram of the control circuit 46.

The control circuit 46 transitions from an idle state S1 to a decoding state S2 when a command C4 is input (Not empty) to the command queue 45.

In the decoding state S2, the control circuit 46 decodes a command C4 output from the command queue 45. Additionally, the control circuit 46 reads semaphores S stored in the register 61 in the controller 6, and determines whether or not operations can be executed in the multiplier 42 and the accumulator circuit 43 instructed by the command C4. If operations cannot be executed (Not ready), then the control circuit 46 waits (Wait) until the operations become executable. If the operations are executable (ready), then the control circuit 46 transitions from the decoding state S2 to an execution state S3.

In the execution state S3, the control circuit 46 controls the multiplier 42 and the accumulator circuit 43 to make the multiplier 42 and the accumulator circuit 43 implement the operations instructed by the command C4. When the operations in the multiplier 42 and the accumulator circuit 43 end, the control circuit 46 removes the command C4 that has been executed from the command queue 45 and updates the semaphores S stored in the register 61 in the controller 6. If there is a command in the command queue 45 (Not empty), then the control circuit 46 transitions from the execution state S3 to the decoding state S2. If there are no commands in the command queue 45 (empty), then the control circuit 46 transitions from the execution state S3 to the idle state S1.

The execution model generation unit 321 determines the specifications and the sizes (Bc and Bd) of the computing devices in the convolution operation circuit 4 from information such as the bit widths of the weights w and the input data a that are input as network information NW. In the case in which the hardware scale of the NN execution model 100 (neural network hardware model 400, neural network hardware 600) to be generated is included in the hardware information HW, the execution model generation unit 321 adjusts the specifications and the sizes (Bc and Bd) of the computing devices in the convolution operation circuit 4 in accordance with the designated scale.

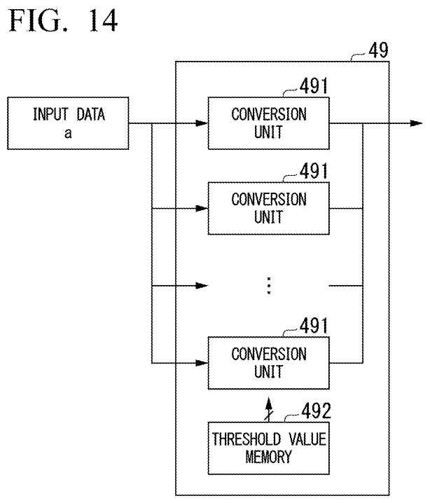

FIG. 14 is a block diagram of the input conversion unit 49.

The input conversion unit 49 converts input data a including many bits (8 bits or more) to values of 8 bits or less. The input conversion unit 49 has a function corresponding to that of the input layer of the CNN 200. The input conversion unit 49 has multiple conversion units 491 and a threshold value memory 492.

In this case, in the explanation of the input conversion unit 49, the input data a will be assumed to be image data in which the number of elements in the c-axis direction is 1 (i.e., a two-dimensional image in the xy plane). Additionally, the image data is assumed to be provided with a matrix-type data structure in which many-valued pixel data of 8 bits or more is provided as each element in the x-axis direction and the y-axis direction. When this input data a is converted by the input conversion unit 49, each element is quantized and becomes a low-bit (for example, a 2-bit or 1-bit) value.

The conversion units 491 compare the respective elements in the input data a with prescribed threshold values, The conversion units 491 quantize the respective elements of the input data a based on the comparison results, The conversion units 491 quantize, for example, 8-bit input data a to 2-bit or 1-bit values. The conversion units 491, for example, perform quantization in a manner similar to the quantization performed by the quantization layers 224. Specifically, the conversion units 491 compare the respective elements of the input data a with threshold values as indicated in Equation 6, and output the results thereof as quantization results. In the case in which the quantization performed by the conversion units 491 is 1-bit quantization, a single threshold value is used, and in the case of 2-bit quantization, three threshold values are used.

The input conversion unit 49 includes c0 conversion units 491, and each conversion unit 491 performs quantization using threshold values that are independent for the same element. That is, the input conversion unit 49 outputs a maximum of c0 computation results with respect to the input data a. The bit precision of the conversion values that are output by the conversion units 491 and that are the result of conversion of the input data a may be changed, as appropriate, based on the hit precision of the input data a, etc.

The threshold value memory 492 is a memory that stores multiple threshold values th used for the operations in the conversion units 491. The threshold values th stored in the threshold value memory 492 are prescribed values that are set with respect to each of the c0 conversion units 491. Each threshold value th is a parameter to be learned, and is determined and updated by executing the learning step to be described below.

The image data is linked to the data structure of a three-dimensional tensor having c0 elements in the c-axis direction. That is, the process performed by the input conversion unit 49 corresponds to bit reduction of the respective sets of pixel data among the image data, and to the generation of c0 sets of image data generated based on different threshold values. In this case, the outputs from the c0 conversion units 491 are output to the multiplier 42 as three-dimensional data structures comprising the elements (x, y, c0) by being linked in the c-axis direction.

When the input conversion unit 49 is not provided, high-bit multiplication operations are required in the multiplier 42, and there are cases in which computational resources in the c-axis direction, which are installed as hardware, are wasted. Meanwhile, the input data a is quantized by providing the multiplier 42 before the input conversion unit 49, thereby not only allowing the multiplication operations in the multiplier 42 to be replaced with simple logic operations, but also allowing the above-mentioned computational resources to be utilized efficiently.

In the present embodiment, an example in which the same element of input data a is input to multiple conversion units 491 has been described. However, the mode of the input conversion unit 49 is not limited thereto. For example, in the case in which the input data a is image data including three or more channels of elements including color components, the data may be divided into multiple groups corresponding to the conversion units 491, and elements corresponding to each of the groups may be input and converted. Additionally, the elements input to prescribed conversion units 491 other than color components may be subjected to some sort of conversion preprocessing, or the conversion units 491 to which they are input may be switched in accordance with whether or not they have been preprocessed. Additionally, the conversion process does not need to be performed with respect to all of the elements of the input data a, and for example, the conversion process may be performed only with respect to elements corresponding to a specific color, which are specific elements in the input data a.

Additionally, different elements of the input data a may be input to the multiple conversion units 491. In this case, the input conversion unit 49 merely functions as a unit for quantizing the input data a.

The value of the number c0 of conversion units 491 is preferably not a fixed value, but rather a value that is determined, as appropriate, in accordance with the network structure of the NN execution model 100 or the hardware information HW. In the case in which there is a need to compensate for reduced computational precision due to the quantization by the conversion units 491, the number of the conversion units 491 is preferably set to be equal to or greater than the bit precision of the respective elements of the input data a. More generally, the number of the conversion units 491 is preferably set to be equal to or greater than the difference in bit precision of the input data a before and after quantization. Specifically, when 8-bit input data a is quantized to 1 bit, the number of the conversion units 491 should preferably be set to 7 or more (e.g., 16 or 32), corresponding to the 7 bits that are the difference.

The input conversion unit 49 is not necessarily required to be installed as hardware. The conversion process may be performed on the input data a as preprocessing in a software generation step (S17) to be described below.

### <Quantization Operation Circuit Generation Step (S13-2)>

The execution model generation unit 321 generates a quantization operation circuit 5 of the NN execution model 100 based on the hardware information HW and the network information NW (quantization operation circuit generation step). The execution model generation unit 321 generates a hardware model of the quantization operation circuit 5 from quantization information input as the network information NW. The hardware model may be at the behavior level or may be at the RTL (Register Transfer Level), may be a net list indicating connections between gates and circuit modules, or may be a combination thereof.

### <DMAC Generation Step (S13-3)>

The execution model generation unit 321 generates a DMAC 3 of the NN execution model 100 based on the hardware information HW and the network information NW (DMAC generation step). The execution model generation unit 321 generates a hardware model of the DMAC 3 from information input as the network information NW The hardware model may be at the behavior level or may be at the RTL (Register Transfer Level), may be a net list indicating connections between gates and circuit modules, or may be a combination thereof.

### <Learning Step (S14)>

In step S14, the learning unit 322 and the inference unit 323 of the neural network generation device 300 use the training data set DS to learn the learned parameters of the generated NN execution model 100 (learning step). The learning step (S14) has, for example, a learned parameter generation step (S14-1) and an inference testing step (S14-2).

### <Learning Step: Learned Parameter Generation Step (S14-1)>

The learning unit 322 uses the NN execution model 100 and training data D1 to generate learned parameters PM. The learned parameters PM are learned weights w, quantization parameters q, threshold values of the input conversion unit 49, and the like.

For example, in the case in which the NN execution model 100 is an execution model for a CNN 200 for implementing image recognition, the training data. D1 is a combination of input images and teacher data T. The input images are input data a input to the CNN 200. The teacher data T is the type of an object captured in an image, the presence or absence of a detection target in the image, coordinate values of a detection target in the image, or the like.

The learning unit 322 generates the learned parameters PM by means of teacher-based learning using error backpropagation, which is a known technique, or the like. The learning unit 322 determines differences E between the outputs from the NN execution model 100 for input images and teacher data T corresponding to the input images by means of a loss function (error function), and updates the weights w and the quantization parameters q so as to make the differences E smaller. Additionally, the learning unit 322 updates the normalization parameters used when normalizing the data distribution in a batch normalization performed in the quantization operation circuit 5. Specifically, the learning unit 322 updates the scale a and the bias B indicated in Equation 4.

For example, when updating the weights w, the gradients of loss functions relating to the weights w are used. The gradients are computed, for example, by taking the derivatives of the loss functions. In the case in which the error backpropagation method is used, the gradients are computed by backward propagation.

When computing the gradients and updating the weights w, the learning unit 322 increases the precision of the computations associated with the convolution operations. Specifically, 32-bit floating-point weights w, which are more precise than the low-bit weights w 1 bit) used by the NN execution model 100, are used for training. Additionally, the precision of convolution operations implemented by the convolution operation circuit 4 in the NN execution model 100 is increased.

When computing the gradients and updating the weights w, the learning unit 322 increases the precision of the computations associated with the activation function. Specifically, a sigmoid function, which is more precise than an activation function such as the ReLU function implemented by the convolution operation circuit 5 in the NN execution model 100, is used for training.

Meanwhile, when the learning unit 322 computes output data with respect to an input image by means of forward propagation, operations based on the NN execution model 100 are implemented without increasing the precision of the computations associated with the activation function and the convolution operations. The highly precise weights w used when updating the weights w are converted to low-bit values by means of a lookup table or the like.

When computing the gradients and updating the weights w, the learning unit 322 can prevent decreases in the precision of intermediate data in computations by increasing the precision of the computations associated with the activation function and the convolution operations, thereby generating learned parameters PM by which high inference precision can be realized.

Meanwhile, when computing output data with respect to an input image, the learning unit 322 performs computations based on the NN execution model 100 without increasing the precision of forward propagation computations. For this reason, the output data computed by the learning unit 322 matches the output data from the NN execution model 100 using a learned parameter PM that has been generated.

Furthermore, the learning unit 322 determines a threshold value th by considering the learned weights w and the quantization parameters q. The learning unit 322 uses the scale a and the bias B included in the normalization parameter to update the threshold value th. As one example, when the scale updated by learning is represented by a, the bias is represented by B, and the initial value of the threshold value th is represented by th0, the threshold value th is updated based on the normalization parameter updated, by learning, as th=(th0−B)/a. In this case, the normalization parameter was explained under the assumption that the parameter relates to a first-order function. However, for example, the parameter may relate to a non-linear monotonically increasing or monotonically decreasing function, Additionally, the threshold value th may be updated by using the weights 142, the quantization parameters q, or a combination thereof, rather than the normalization parameter.

### <Learning Step: Inference Testing Step (S14-2)>

The inference unit 323 uses the learned parameters PM generated by the learning unit 322, the NN execution model 100 and the test data D2 to implement an inference test. For example, in the case in which the NN execution model 100 is an execution model of a CNN 200 for implementing image recognition, the test data D2, like the training data D1, is a combination of an input image and teacher data T.

The inference unit 323 displays the progress and results of the inference test on the display unit 350. The results of the inference test are, for example, the correct answer rate with respect to the test data D2.

### <Confirmation Step (S15)>

In step S15, the inference unit 323 in the neural network generation device 300 displays, on the display unit 350, a message prompting the user to input confirmation of the results by using the manual operation input unit 360 and a GUI image necessary for inputting information. The user inputs, from the manual operation input unit 360, whether or not the results of the inference test are acceptable. If an input indicating acceptability of the inference test results has been input by the user from the manual operation input unit 360, then the neural network generation device 300 next implements step S16. If an Input indicating that the results of the inference test are unacceptable to the user is input from the manual operation input unit 360, then the neural network generation device 300 implements step S12 again. The neural network generation device 300 may return to step S11 have the user input the hardware information HW again.

### <Output Step (S16)>

In step S16, the hardware generation unit 324 in the neural network generation device 300 generates a neural network hardware model 400 based on the hardware information HW and the NN execution model 100.

### <Software Generation Step (S17)>

In step S17, the software generation unit 325 in the neural network generation device 300 generates software 500 for operating neural network hardware 600 (the neural network hardware model 400 installed in the operated hardware) based on the network information NW, the NN execution model 100, and the like. The software 500 includes software for transferring learned parameters PM to the neural network hardware 600 as needed.

The software generation step (S17) includes, for example, an input data conversion step (S17-1), an input data partitioning step (S17-2), a network partitioning step (S17-3), and an allocation step (S17-4).

### <Input Data Conversion Step (S17-1)>

When the input conversion unit 49 is not installed, as hardware, in the convolution operation circuit 4, the software generation unit 325, as preprocessing, converts changeable input data a in advance to generate converted input data a′. The conversion method of the input data a in the input data conversion step is the same as the conversion method in the input conversion unit 49.

### <Input Data Partitioning Step (S17-2)17-2): Data Partitioning>

The software generation unit 325 partitions input data a for convolution operations in the convolution layers 210 into partial tensors based on the memory capacities of memory to be allocated as the first memory 1 and the second memory 2, the specifications and the sizes (Bc and Bd) of the computing devices, or the like. The method for partitioning into the partial tensors and the number of partitions are not particularly limited. The partial tensors are formed, for example, by partitioning the input data a(x+i, y+j, c) into a(x+i, y+j, co).

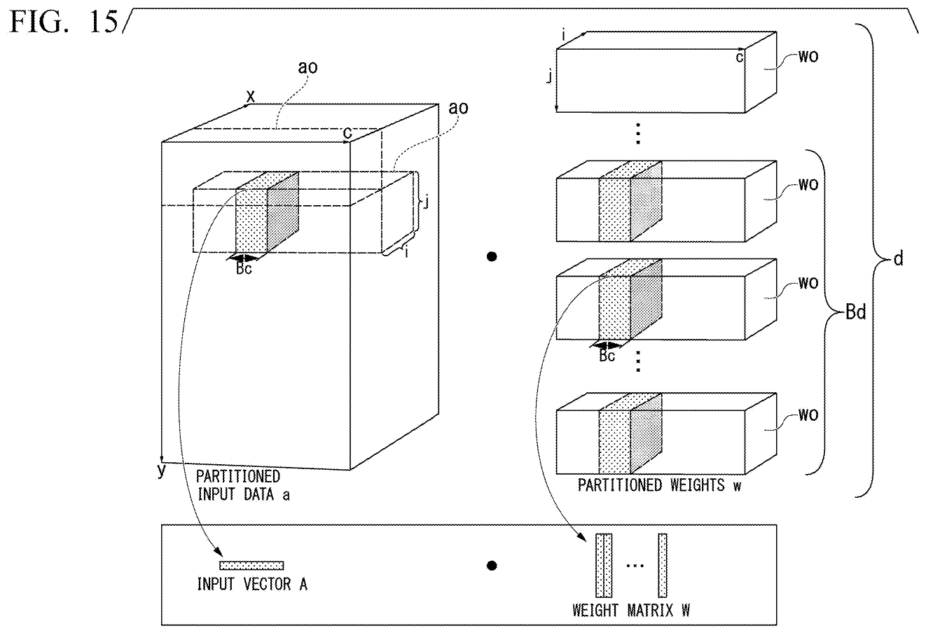

FIG. 15 is a diagram for explaining data partitioning and data expansion in a convolution operation.

In data partitioning in a convolution operation, the variable c in Equation 1 is partitioned into blocks of size Bc, as indicated by Equation 7. Additionally, the variable d in Equation 1 is partitioned into blocks of size Bd, as indicated by Equation 8. In Equation 7, co is an offset, and ci is an index from 0 to (Bc−1). In Equation 8, do is an offset, and di is an index from 0 to (Bd−1). The size Bc and the size Bd may be the same.

c=co·Bc+ci [Equation 7]

d=do·Bd+di [Equation 8]

The input data a(x+i, y+j, c) in Equation 1 is partitioned into the size Bc in the c-axis direction and is expressed as the partitioned input data a(x+i, y+j, co). In the explanation below, input data a that has been partitioned is also referred to as “partitioned input data a”.

The weight w(i, j, c, d) in Equation 1 is partitioned into the size Bc in the c-axis direction and into the size Bd in the d-axis direction, and is expressed as the partitioned weights w (i, j, co, do). In the explanation below, a weight w that has been partitioned will also referred to as a “partitioned weight w”.

The output data f(x, y, do) partitioned into the size Bd is determined by Equation 9. The final output data f(x, y, d) can be computed by combining the partitioned output data J(x, y, do).

f(x, y, do)=Σᵢ^{k}Σⱼ^{k}Σ_{co}^{C/Bc}a(s·x+i, s·y+j, co)·w(i, j, co, do) [Equation 9]

### <Input Data Partitioning Step (S17-3): Data Expansion>

The software generation unit 325 expands the input data a and the weights that have been partitioned in a convolution operation circuit 4 in the NN execution model 100.

The partitioned input data a(x+i, y+j, co) is expanded into vector data having Bc elements. The elements in the partitioned input data a are indexed bye ci (where 0≤ci<Bc). In the explanation below, partitioned input data a expanded into vector data for each of i and j will also be referred to as “input vector A”. An input vector A has elements from partitioned input data a(x+i, y+j, co×Bc) to partitioned input data a(x+i, y+j, co×Bc+(Bc−1)).

The partitioned weights w(i, j, co, do) are expanded into matrix data having Bc×Bd elements. The elements of the partitioned weights w expanded into matrix data are indexed by ci and di (where 0≤di<Bd). In the explanation below; a partitioned weight w expanded into matrix data for each of i and j will also be referred to as a “weight matrix W”. A weight matrix W has elements from a partitioned weight w(i,j, co×Bc, do×Bd) to a partitioned weight w(i, j, co×Bc+(Bc−1), do×Bd+(Bd−1)).

Vector data is computed by multiplying an input vector A with a weight matrix W. Output data f(x, y, do) can be obtained by formatting vector data computed for each of i, j, and co as a three-dimensional tensor. By expanding data in this manner, the convolution operations in the convolution layers 210 can be implemented by multiplying vector data with matrix data.

### <Allocation Step (S17-4)>

The software generation unit 325 generates software 500 for allocating the partitioned operations to the neural network hardware 600 for implementation (allocation step). The generated software 500 includes commands C4. When the input data a has been converted in the input data conversion step (S17-1), the software 500 includes the converted input data a′.

As explained above, with the neural network generation device 300, the neural network control method, and the software generation program according to the present embodiment, it is possible to generate and control a neural network that is embeddable in an embedded device such as an IoT device, and that can be made to operate with high performance.

While a first embodiment of the present invention has been described in detail with reference to the drawings above, the specific structure is not limited to this embodiment, and design changes or the like within a range not departing from the spirit of the present invention are also included. Additionally, the structural elements indicated in the embodiments and the modified examples described above may be combined as appropriate.

### Modified Example 1-1

In the above embodiment, the first memory 1 and the second memory 2 were separate memories. However, the first memory 1 and the second memory 2 are not limited to such an embodiment. The first memory 1 and the second memory 2 may, for example, be a first memory area and a second memory area in the same memory.

### Modified Example 1-2

For example, the data input to the NN execution model 100 or the neural network hardware 600 described in the above embodiment need not be limited to a single form, and may be composed of still images, moving images, audio, text, numerical values, and combinations thereof. The data input to the NN execution model 100 or the neural network hardware 600 is not limited to being measurement results from a physical amount measuring device such as an optical sensor, a thermometer, a Global Positioning System (GPS) measuring device, an angular velocity measuring device, a wind speed meter, or the like that may be installed in an edge device in which the neural network hardware model 600 is provided. The data may be combined with different information such as base station information received from a peripheral device by cable or wireless communication, information from vehicles, ships or the like, weather information, peripheral information such as information relating to traffic conditions, financial information, personal information, or the like.

### Modified Example 1-3

While the edge device in which the neural network hardware 600 is provided is contemplated as being a communication device such as a mobile phone or the like driven by a battery or the like, a smart device such as a personal computer, a digital camera, a game device, or a mobile device in a robot product or the like, the edge device is not limited thereto. Effects not obtained by other prior examples can be obtained by utilization in products for which there is a high demand for long-term driving or for reducing product heat generation, or for restricting the peak electric power that can be supplied by Power on Ethernet (PoE) or the like. For example, by applying the invention to an on-board camera mounted on a vehicle, a ship, or the like, or to a security camera or the like provided in a public facility or on a road, not only can long-term image capture be realized, hut also, the invention can contribute to weight reduction and higher durability. Additionally, similar effects can be achieved by applying the invention to a display device such as a television or a monitor, to a medical device such as a medical camera or a surgical robot, to a work robot used at a manufacturing site or at a construction site, or the like.

### Second Embodiment

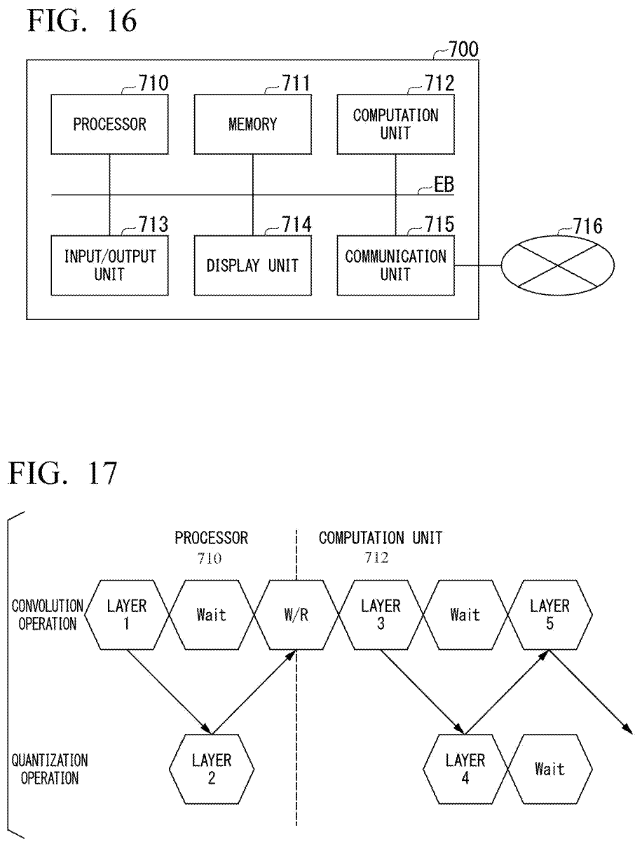

Electronic equipment (neural network computing device) 700 according to a second embodiment of the present invention will be explained with reference to FIG. 16 to FIG. 18. In the explanation below, the features that are the same as those that have already been explained will be assigned the same reference numbers and redundant explanations will be omitted.

FIG. 16 is a diagram for explaining an example of the structure of electronic equipment 700 including neural network hardware 600. The electronic equipment 700 is a mobile product driven by a power supply such as a battery. One example is an edge device such as a mobile phone. The electronic equipment 700 is provided with a processor 710, a memory 711, a computation unit 712, an input/output unit 713, a display unit 714, and a communication unit 715 that communicates with a communication network 716. In the electronic equipment 700, the functions of an NN execution model 100 are realized by combining the respective constituent elements.

The processor 710 is, for example, a CPU (Central Processing Unit), which reads and executes software 500 prestored in the memory 711, and which realizes the respective functions of the neural network hardware 600 together with the computation unit 712. Additionally, the processor 710 may read and execute programs other than the software 500, and may realize functions that are necessary for realizing the functions of a deep learning program.

The memory 711 is, for example, a RAM (Random Access Memory) that prestores the software 500, including command groups, various parameters, etc., which is read and executed by the processor 710. Additionally, the memory 711 stores image data and various types of configuration files for using a GUI to be displayed on the display unit 714. The memory 711 is not limited to RAM and may, for example, be an HDD (Hard Disk Drive), an SSD (Solid-State Drive), a flash memory, or a ROM (Read-Only Memory), or may be a combination thereof.

The computation unit 712 includes one or more functions of the NN execution model 100 indicated in FIG. 5, and realizes the respective functions of the neural network hardware 600 by cooperating with the processor 710 via an external bus EB. Specifically, it reads the input data a via the external bus EB, performs various types of computations associated with deep learning, and writes the results thereof in the memory 711, etc.

The input/output unit 713 is, for example, an input/output port. Connected to the input/output unit 713 are, for example, input devices such as one or more camera devices, a mouse and a keyboard, and output devices such as a display or a speaker. The camera devices are, for example, cameras connected to a drive recorder or a security monitoring system. Additionally, the input/output unit 713 may include a universal data input/output port such as a USB port.

The display unit 714 has various types of monitors such as an LCD display. The display unit 714 can display GUI images and the like. Additionally, when the processor 710 requires information to be input from a user, the display unit 714 can display a message prompting a user to input information from the input/output unit 713 and a GUI image necessary for inputting information.

The communication unit 715 is an interface circuit for communicating with other equipment via the communication network 716. Additionally, the communication network 716 is, for example, a WAN (Wide Area Network), a LAN (Local Area Network), the internet, or an intranet. Additionally, the communication unit 716 has not only functions for transmitting various types of data including computation results associated with deep learning, but also, functions for receiving prescribed data from an external device such as a server. For example, the communication unit 715 receives, from an external device, various types of programs executed by the processor 710, parameters included in said programs, learning models used for machine learning, and programs and learned results for learning the learning models.

Some of the functions of the processor 710 or the computation unit 712 may be realized, for example, by one or more processors, such as a CPU (Central Processing Unit) or a GPU (Graphics Processing Unit) executing a program stored in a program memory. Some or all of the functions of the computation unit 712 may be realized by means of hardware (e.g., circuitry) such as an LSI (Large-Scale Integrated circuit), an ASIC (Application-Specific Integrated Circuit), an FPGA (Field-Programmable Gate Array), or a PLD (Programmable Logic Device). Additionally, some of the functions of the computation unit 712 may be realized by combining software and hardware.

Next, the operations of the electronic equipment (neural network computing device) 700 will be explained.

The neural network hardware 600 is formed in the shape of a loop in which a convolution operation circuit 4 and a quantization operation circuit 5 are connected by two memories. As a result thereof, convolution operations can be efficiently implemented on the quantized input data a and the weights w. However, when special operations are to be executed, there are cases in which the efficiency becomes lower.

The respective constituent elements of the neural network hardware 600 are controlled by a controller 6 that operates as a slave of the processor 710. The controller 6 sequentially reads command sets stored in a prescribed area of the memory 711 in synchronization with writing into an operation register by the processor 710. The processor 710 controls the respective constituent elements in accordance with the command set that has been read, thereby performing operations associated with the NN execution model 100.

Meanwhile, there is no need for all of the computations of the NN execution model 100 to be executed by the neural network hardware 600, and some of the computations may be performed, for example, by the processor 710, which is an external computational resource. Specifically, by having the processor 710 perform some or all of the computations for the input layer or the output layer, or high-bit computations that would lower the computational efficiency when executed by the neural network hardware 600, the range of possible computations can be broadened without lowering the computational efficiency.

For the present embodiment, the case in which, in the input layer, computations for converting (conversions corresponding to the input conversion unit 49) high-bit input data a (e.g., image data, etc.) are implemented by the processor 710, and subsequent convolution operations are implemented by the computation unit 712 including the neural network hardware 600 will be explained.

FIG. 17 is a timing chart indicating an example of implementation of computational processing operations of the NN execution model 100 by the processor 710 and the computation unit 712 in the electronic equipment 700. Hardware resources can be efficiently utilized by performing some of the computations of the NN execution model 100 in the processor 710, and performing subsequent computations by means of the neural network hardware 600 having a loop-shaped circuit configuration, thereby making the computations overall more efficient.

The processor 710 reads the input data a stored in the memory 711. The processor 710 executes a prescribed program to convert (conversions corresponding to the input conversion unit 49) the input data a.

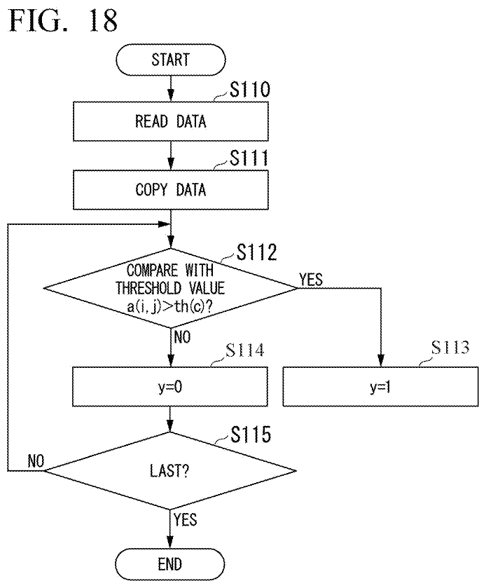

FIG. 18 is a flow chart indicating the operations of a program for converting the input data a executed by the processor 710. First, the processor 710 reads some of the input data a from the memory 711 in step S110. Specifically, the processor 710 reads the input data a in units by which the convolution operations are to be performed. The processor 710 preferably reads the input data a in accordance with the size of the memory provided in the neural network hardware 600. As a result thereof, the data that has been processed by the processor 710 can be efficiently processed by the computation unit 712, which is in a latter stage. Suppose that the input data a to be processed in the present embodiment is image data having 32 elements in the x-axis direction, 32 elements in the y-axis direction, and one element in the c-axis direction (i.e., a two-dimensional image in the xy plane).

In step S111, the processor 710 prepares c0 copies of the input data a read out in step S110. In this case, the target data to be copied is 32×32 sets of pixel data, which are all of the elements of the input data a. The target data to be copied may be the data for a single pixel, or may be input data (e.g., input data for nine pixels) for which a convolution operation can be performed at the same time. Additionally, although the number c0 of copies generated in the present embodiment is 32, there may be a different number of copies. The number c0 of copies produced is preferably set to be the same number as or a multiple of the number of channels that can be processed by the computation unit 712.

In step S112, the processor 710 compares the pixel data a(i, j), which are elements of the input data a copied in step S111, with corresponding threshold values th(c) that were determined by learning in advance. The symbol c represents an index from 0 to (c0−1). In the present embodiment, an example in which c0 copies of the input data a are prepared has been indicated. However, the mode of conversion of the input data a is not limited thereto. For example, when the input data a is image data including elements for three or more channels including color components, each of the c0 converted data may be different. Although the threshold values th(c) are parameters that are learned in advance and stored in the memory 711, they may be acquired, as appropriate, via the communication unit 715 from an external device such as a server or host equipment. Additionally, the processing in step S112 may be performed for multiple sets of pixel data in parallel rather than separately for each set of pixel data.

In step S113, the processor 710 outputs “1” as the output y when, as a result of the comparison in step S112, the pixel data aij is greater than the threshold value th(c). On the other hand, in step S114, the processor 710 outputs “0” as the output y when, as a result of the comparison in step S112, the pixel data aij is equal to or less than the threshold value th(c). As a result thereof, a binary value having a width of c0 bits is produced. In this case, the output y in step S112 is not limited to a 1-bit value, and may be a multi-bit value such as a 2-bit or 4-bit value.

The processor 710 repeats step S112 to step S115 and implements the conversion process on all of the pixel data for all conversion targets.

As indicated in FIG. 17, the processor 710, after converting the input data a, performs a layer-1 convolution operation on the converted input data a.

The processor 710 performs a layer-2 quantization operation on the data including multi-bit elements that are the results of the convolution operation in layer 1. Said operation is the same as the operation executed by the quantization operation circuit 5 included in the computation unit 712. In the case in which the processor 710 performs a quantization operation, the sizes of filters, the computational bit precision and the like may be different from those in the quantization operation circuit 5. The processor 710 writes the quantization operation results back in the memory 711.

The computation unit 712 commences computation in response to a prescribed wait process or control by a register for commencing computation by the processor 710. Specifically, after the layer-2 quantization operation ends and the data has been written into the memory 711, the computation unit 712 reads out said data and sequentially executes a layer-3 convolution operation, a layer-4 quantization operation, and necessary latter-stage processes.

As explained above, when performing, operations associated with the neural network, the computational efficiency can be improved by quantizing the input data a on which the computations are to be performed. Furthermore, in the case in which the input data a has many bits, reductions in the computational precision can be suppressed while also improving the computational efficiency by providing a conversion process (quantization process) for the input data a.

While a second embodiment of the present invention has been described in detail with reference to the drawings above, the specific structure is not limited to this embodiment, and design changes or the like within a range not departing from the spirit of the present invention are also included. Additionally, the structural elements indicated in the embodiments and the modified examples described above may be combined as appropriate.

### Modified Example 2-1

In FIG. 17, an example in which the processor 710 and the computation unit 712 implement the computational processing operations by using the memory 711 is indicated. However, the combination of elements performing the computational processing operations is not limited thereto.

For example, the computation unit 712 may perform the processing for at least some of the processes such as the comparison process in the input conversion unit 49. As one example, the quantization operation circuit 5 may perform the comparison process of the input conversion unit 49. in this case, the input data a may be modified to a size capable of being stored in the second memory 2. Additionally, the processor 710 may write the layer-2 processing results directly into a memory in the computation unit 712, without using the memory 711. Additionally, in the case in which the layer-1 convolution operation results are temporarily stored in the memory 711 or the like, the layer-2 quantization operation may be performed by the computation unit 712 via the second memory 2.

Additionally, in FIG. 17, an example in which the computational processing in the processor 710 and the computational processing in the computation unit 712 are implemented in a time-divided manner is indicated. However, the computations can be processed in parallel in the case in which multiple sets of input data a are to be processed, etc. As a result thereof, the computations can be made even more efficient.

A program for an embodiment described above may be recorded on a computer readable recording medium, and the program recorded on this recording medium may be read into a computer system and executed to realize the embodiment. The “computer system” mentioned here includes an OS and hardware such as peripheral devices. Additionally, the “computer-readable recording medium” refers to a portable medium such as a flexible disk, a magneto-optic disk, a ROM, or a CD-ROM, or to a storage medium such as a hard disk internal to the computer system. Furthermore, the “computer-readable recording medium” may include media that dynamically hold the program for a brief period of time, such as communication lines in the case in which the program is transmitted via a network such as the internet or communication lines such as telephone lines, and media that hold the program for a certain period of time, such as transitory memory inside the computer system functioning as a server or a client in such cases. Additionally, the above-mentioned program may be for realizing just some of the aforementioned functions, and furthermore, the aforementioned functions may be realized by being combined with a program already recorded in the computer system.

Additionally, the effects described in the present specification are merely explanatory or exemplary, and are not limiting. In other words, the features in the present disclosure may, in addition to the effects mentioned above or instead of the effects mentioned above, have other effects that would be clear to a person skilled in the art from the descriptions in the present specification.

### Industrial Applicability

The present invention can be applied to the generation of a neural network.

### REFERENCE SIGNS LIST

300 Neural network generation device
200 Convolutional neural network (CNN)
100 Neural network execution model (NN execution model)
400 Neural network hardware model
500 Software
600 Neural network hardware(neural network computing device)
1 First memory
2 Second memory
3 DMA controller (DMAC)
4 Convolution operation circuit
42 Multiplier
43 Accumulator circuit
49 Input conversion unit
5 Quantization operation circuit
6 Controller
PM Learned parameter
DS Training data set
HW Hardware information
NW Network information

1. A neural network generation device that generates a neural network execution model for performing operations of a neural network, wherein:
the neural network execution model converts input data including elements with 8 bits or more to converted values with fewer bits than the elements, based on comparisons with multiple threshold values.

2. The neural network generation device according to claim 1, wherein:
the neural network execution model converts at least some of the elements of the input data to the converted values with 2 bits or fewer.

3. The neural network execution model generation device according to claim 1, comprising:
a learning unit that learns learned parameters of the neural network execution model;
wherein the learning unit generates the threshold values and weights used in convolution operations implemented by the neural network.

4. The neural network execution model generation device according to claim 1 comprising:
a software generation unit that generates software for operating neural network hardware in which the neural network execution model is at least partially installed in the hardware;
wherein the software generation unit generates the software, which converts the input data to the converted values, and which inputs the converted values to the neural network hardware.

5. A neural network computing device comprising:
an input conversion unit that converts input data including elements with 8 bits or more to converted values with fewer bits than the elements, based on comparisons with multiple threshold values; and
a convolution operation circuit to which the converted values are input.

6. The neural network computing device according to claim 5, wherein:
the input conversion unit converts at least some of the elements of the input data to the converted values with 2 bits or fewer.

7. The neural network computing device according to claim 6, wherein:
the input conversion unit has multiple conversion units that convert the input data to the converted values; and
the number of the multiple conversion units is equal to or greater than a difference in bit precision before and after conversion by the conversion units.

8. An edge device comprising:
the neural network computing device according to claim 5; and
a power supply for operating the neural network computing device.

9. A neural network control method for controlling neural network hardware for performing operations of a neural network, the method comprising:
a conversion step for converting input data including elements with 8 bits or more to converted values with fewer bits than the elements, based on comparisons with multiple threshold values; and
a computation step for implementing convolution operations on the converted values.

10. The neural network control method according to claim 9, wherein:
the conversion step is processed in advance by a device other than the neural network hardware.

11. A non-transitory computer-readable recording medium storing a software generation program that generates software for controlling neural network hardware for performing operations of a neural network, wherein the program generates the software, which includes:
a conversion step for converting input data including elements with 8 bits or more to converted values with fewer bits than the elements, based on comparisons with multiple threshold values; and
a computation step for implementing convolution operations on the converted values.

12. A non-transitory computer-readable recording medium storing a software generation program that generates software for controlling neural network hardware for performing operations of a neural network, wherein the program generates the software, which includes:
a computation step for implementing a convolution operation by using converted values obtained by converting input data including elements with 8 bits or more to converted values with fewer bits than the elements, based on comparisons with multiple threshold values.
